(19) United States
(12) Patent Application Publication
(10) Pub. No.: US 2004/0207364 A1
(43) Pub. Date: Oct. 21, 2004

(54) Connecting device for an electric work vehicle

(76) Inventors: Ettore Uguzzoni, Spilamberto (IT); Mauro Nervosi, Marano Sul Panaro (IT)

Correspondence Address: Modiano & Associati, Via Meravigli 16, Milano, 20123, IT

(21) Appl. No.: 10/487,676

(22) PCT Filed: Mar. 27, 2002
(86) PCT No.: PCT/IT02/00197

(30) Foreign Application Priority Data
Aug. 31, 2001 (IT) B 02001A000527

(51) Int. Cl. H02J 7/00

(52) U.S. Cl. 320/128

(57) ABSTRACT

A connecting device for an electric work vehicle, having a supporting body (8) made of insulating material and housing at least a first and a second supply cable (10, 11)connectable to a battery (5) and selectively connectable to a battery charger (7) and to at least one user device (3). The connecting device also has an electronic control circuit (12) connected to the first and second supply cable (10, 11); and a current transducer (13) for detecting a current flowing in the first and second supply cable (10, 11).

The present invention relates to a connecting device for an electric work vehicle.

### BACKGROUND OF THE INVENTION

As is known, numerous mechanical devices, such as fork-lift trucks or conveyors, are powered by electric motors, which must supply high power levels, e.g. in the region of tens of kilowatts. Such devices must obviously be equipped with a battery (drive battery) connectable selectively to the electric motor and any other user devices during normal operation, and to a battery charger for routine charging; which connection is made using special connectors capable of withstanding extremely high current (of over 300 A).

Operation and particularly charging of the battery are monitored by electronic control circuits, which are normally included in the battery charger, and which, in particular, measure the battery voltage and various other operating parameters, such as temperature, and interrupt charging when the battery voltage reaches a predetermined threshold.

Since the battery voltage, however, is also affected by external environmental factors and by ageing of the battery components, such a method fails to provide for accurately controlling the actual charge of the battery, or for monitoring discharge of the battery during normal operation, i.e. when the battery is connected to the user devices as opposed to the charger.

In either case, the actual charge may be much lower than estimated on the basis of the battery voltage.

This clearly constitutes a serious drawback, by the autonomy of a user device powered by an undercharged battery being less than predicted.

### SUMMARY OF THE INVENTION

It is an object of the present invention to provide a connecting device designed to eliminate the aforementioned drawbacks.

According to the present invention, there is provided a connecting device as claimed in claim 1.

Said electronic control circuit is housed in a seat on said supporting body.

The connecting device so formed advantageously provides for measuring current flow in the supply cables both when charging and during normal operation (discharging) of the battery, so that the overall charge of the battery can be determined accurately instant by instant. For which purpose, in particular, the electronic control circuit is used.

Moreover, the connecting device is cheap and easy to produce, is compact, and can be installed extremely easily.

### BRIEF DESCRIPTION OF THE DRAWINGS

A non-limiting embodiment of the invention will be described by way of example with reference to the accompanying drawings, in which:

FIG. 1 shows a simplified view in perspective of a fork-lift truck powered by an electric motor;

FIG. 2 shows a simplified block diagram of a system for supplying and recharging the FIG. 1 fork-lift truck;

FIG. 3 shows a cross section of a connecting device in accordance with the present invention;

FIG. 4 shows a top plan view, with parts removed for clarity, of the FIG. 3 connecting device;

FIG. 5 shows a block diagram of part of the FIG. 3 connecting device;

FIGS. 6 and 7 show flow charts of procedures implemented by the FIG. 3 connecting device.

### DESCRIPTION OF THE PREFERRED EMBODIMENTS

The present invention may be applied to advantage, for example, to a fork-lift truck powered by an electric motor, to which reference is made in the following description purely by way of example.

FIG. 1 shows a fork-lift truck 1 with movable arms (forks) 2 for lifting and transporting loads, and powered by an electric motor 3 supplied by a battery 5.

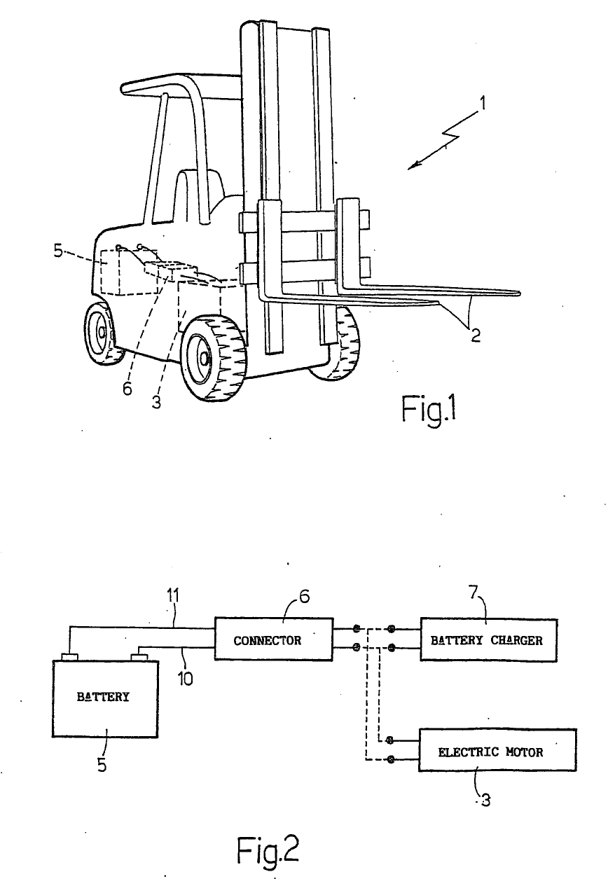

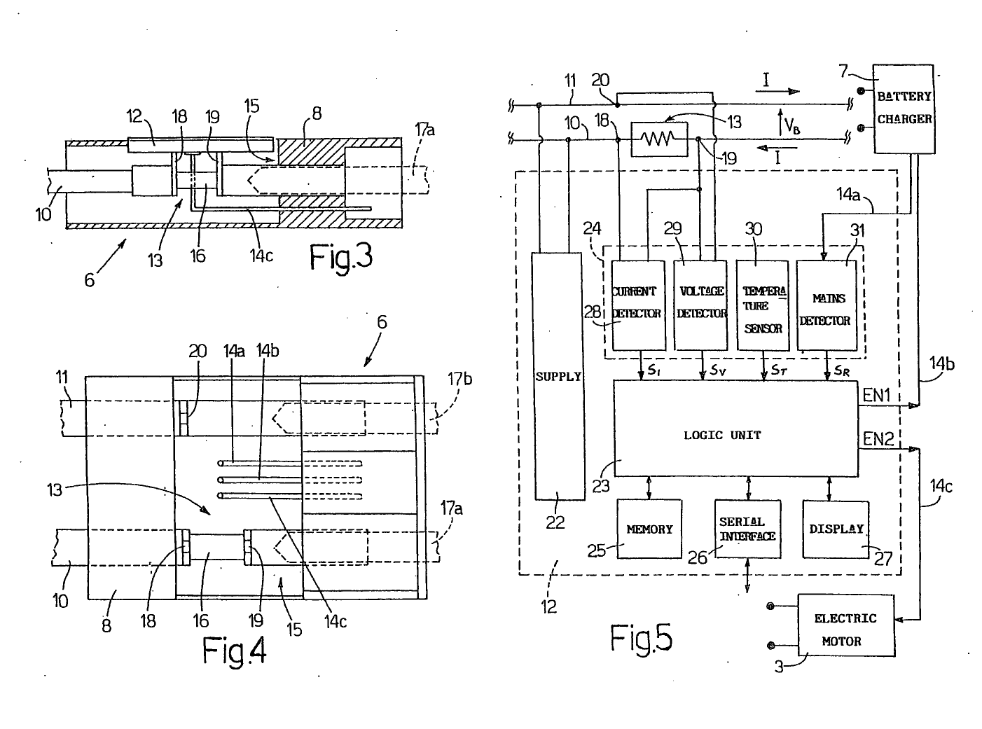

As shown schematically in FIG. 2, battery 5 is connectable selectively, by means of a connecting device 6, to electric motor 3 and to a battery charger 7. More specifically (FIGS. 3 and 4), connecting device 6 comprises a supporting body 8 made of insulating material and housing a first and a second supply cable 10, 11 connected to battery 5; an electronic control circuit 12 housed at least partly in a seat 15 on supporting body 8; and a current transducer 13 for detecting a current I flowing in supply cables 10, 11. Connecting device 6 also comprises a first, a second, and a third control cable 14a, 14b, 14c, also housed in supporting body 8 and connected to the electronic control circuit. More specifically, the first and second control cable 14a, 14b are connectable to battery charger 7, and the third control cable 14c is connectable to electric motor 3. FIGS. 3 and 4 also show, by dash lines, a first and a second connecting element 17a, 17b forming part of a known connector (not shown in detail) connectable to connecting device 6 (and of which connecting cables 50, 51 are provided for connecting electric motor 3 and battery charger 7 to battery 5—FIG. 2).

Current transducer 13 comprises a resistive element (“shunt”) 16 preferably made of manganin and located in series with first or second supply cable 10, 11, e.g. first supply cable 10. At opposite ends, resistive element 16 has a first and a second detecting contact 18, 19 connected to electronic control circuit 12 as explained in detail later on; a third detecting contact 20, also connected to electronic control circuit 12, is provided on second supply cable 11; and current transducer 13 and detecting contacts 18-20 are all housed in seat 15.

As shown in FIG. 5, electronic control circuit 12 comprises a supply circuit 22; a logic processing unit 23; a sensor assembly 24; a memory 25; a serial interface 26; and a display device 27. More specifically, sensor assembly 24 comprises:

a current detecting circuit 28 having two inputs connected respectively to first and second detecting contact 18, 19; and an output connected to logic processing unit 23 and supplying a first control signal S_{I} indicating the current I flowing in supply cables 10, 11;

a voltage detecting circuit 29 having two inputs connected respectively to first and third detecting contact 18, 20; and an output connected to logic processing unit 23 and supplying a second control signal S_{V} indicating the voltage V_{B} between supply cables 10,

a temperature sensor 30 having an output connected to logic processing unit 23 and supplying a third control signal S_{T}; and

a mains detector 31 having an input connectable to battery charger 7 over first control cable 14a; and an output connected to logic processing unit 23 and supplying a fourth control signal S_{R} having a first value when battery 5 is connected to battery charger 7, and a second value when it is not.

Logic processing unit 23 is also connected to memory 25, to serial interface 26, and to display device 27, and has a first output 25a connectable over second control cable 14b to an enabling input of battery charger 7 and supplying a first enabling signal EN1, and a second output 25b connectable over third control cable 14c to a user enabling input of truck 1 and supplying a second enabling signal EN2.

Serial interface 26, in itself known, permits connection to an external electronic computer (e.g. a palmtop computer) to access memory 25, both to read its content (utilization history and charge operations) and to program a number of operating parameters (threshold values, maximum charge times) explained in detail later on.

Display device 27, also of known type, provides for displaying information relative to the status of battery 5, e.g. charge level or any alarms.

In actual use, logic processing unit 23 receives control signals S_{I}, S_{V}, S_{T}, S_{R}, samples them in known manner, and uses them to perform one of the control procedures described in detail later on. On the basis of the value of first control signal S_{I}, showing instant by instant the current I flowing in supply cables 10, 11, the logic processing unit determines the available charge Q_{B} value of battery 5, and records it in memory 25 (normally in ampere-hours, Ah).

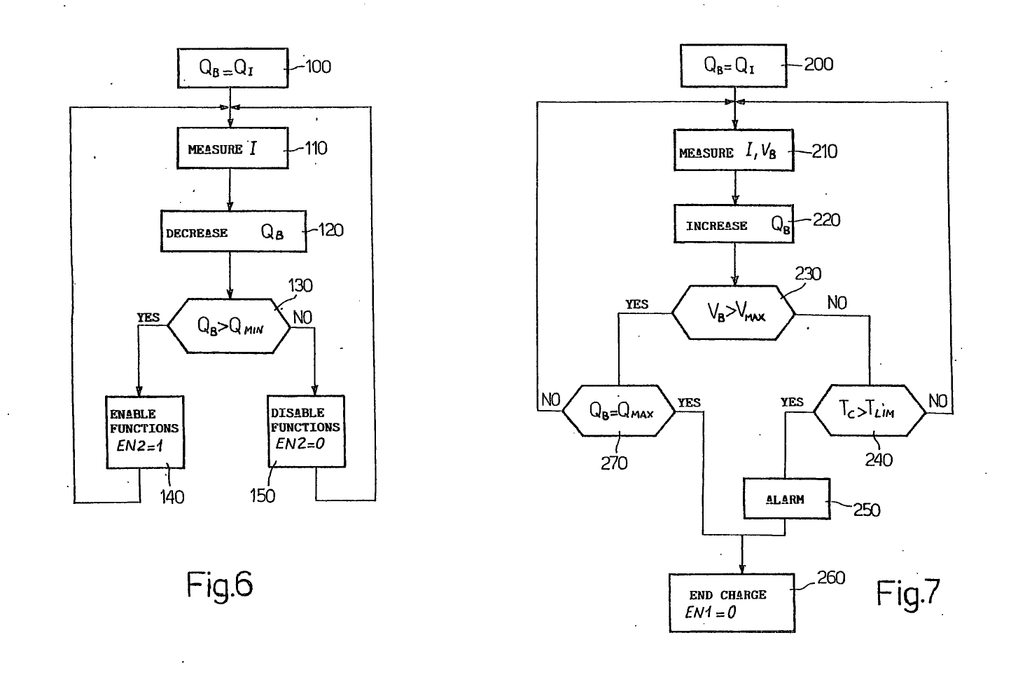

The following is a description, with reference to FIG. 6, of a discharge control procedure performed by logic processing unit 23 when battery 5 is connected to electric motor 3 (in the example shown, when the fork-lift truck is operating). In this case, the second output 25b of the logic processing unit is connected to the enabling input of electric motor 3 over third control cable 14c.

To begin with (block 100), the available charge Q_{B} value of battery 5 is made equal to an initial charge Q_{I} value recorded in memory 25, and which is the charge value determined and memorized after the last time battery 5 is charged or used. The value of current I (block 110) is then measured by means of current detecting circuit 28, and the available charge Q_{B} value is decreased and recorded in memory 25 (block 120). More specifically, the available charge Q_{B} value is calculated by time integration of current I.

The available charge Q_{B} value is then compared with a threshold charge Q_{MIN} value (block 130). If the available charge Q_{B} is higher than the threshold charge (YES output of block 130), the second control signal EN2 is set to a first, e.g. high, logic value to enable normal operation of fork-lift truck 1 (block 140); conversely (NO output of block 130), the second control signal EN2 is set to a second (low) logic value (block 150) to disable operation of forks 2 of truck 1 (e.g. to disable the solenoid valves controlling the hydraulic circuit (not shown) powering forks 2).

In other words, to prevent battery 5 from discharging completely before it can be charged, at least some of the user devices of truck 1 are disabled, and the threshold charge Q_{MIN} is used as a reserve to get truck 1 to battery charger 7.

The cycle of measuring current I (block 110), estimating the available charge Q_{B} (block 120), and monitoring the remaining charge (block 130), is performed continually until battery 5 is disconnected from electric motor 3, or until threshold charge Q_{MIN} is reached.

The following is a description, with reference to FIG. 7, of a charge control procedure performed by logic processing unit 23 when battery 5 is connected to battery charger 7. In this case, the input of mains detector 31 and the first output 25a of the logic processing unit are connected to battery charger 7 over first and second control cable 14a, 14b respectively. More specifically, at this step, mains detector 31 is activated and sets the fourth control signal S_{R} to the first value, so that logic processing unit 23 is controlled to perform the charge control procedure.

To begin with, the available charge Q_{B} value is made equal to the initial charge Q_{I} value recorded in memory 25 (block 200); the values of current I and battery voltage V_{B} are then measured by means of current detecting circuit 28 and voltage detecting circuit 29 respectively (block 210); and the available charge Q_{B} value is then increased and recorded in memory 25 (block 220). In this case too, the available charge Q_{B} is estimated by time integration of current I.

A first test is then performed (block 230), in which the battery voltage V_{B} is compared with a nominal voltage (V_{MAX}) value of, say, 2.4*N V, where N is the number of component elements of battery 5. If the battery voltage V_{B} is less than the nominal voltage V_{MAX} (NO output of block 230), a second test is performed (block 240) to determine whether the charge time T_{C}, since the start of the charge operation, is greater than a limit time T_{LIM}. If it is (YES output of block 240), an alarm is generated and displayed by display device 27 (block 250), the charge procedure is terminated (block 260), the first enabling signal is set to a predetermined (e.g. low) logic value, and battery charger 7 is disabled. Conversely, charging continues, and current I and battery voltage V_{B} are again measured (block 210).

If, on the other hand, battery voltage V_{B} is greater than nominal voltage V_{MAX} (YES output of block 230), a third test is performed to determine whether the available charge Q_{B} has reached a maximum value Q_{MAX} corresponding to the capacity of battery 5 (block 270). If it has (YES output of block 270), the charge procedure is terminated (block 260); if it has not (NO output of block 270), the charge procedure continues. In other words, a double check is made of battery voltage V_{B} and available charge Q_{B}, and the charge procedure is not terminated until battery 5 has been charged sufficiently to restore the maximum charge value Q_{MAX}.

Further advantages of the present invention will be clear from the foregoing description.

In particular, monitoring the current and calculating the remaining charge of the battery provide for optimizing the battery charge procedure by injecting exactly the amount of current required to replace the amount discharged during operation of the battery, thus reducing the time and energy required to charge the battery, and preventing premature ageing of the battery.

Moreover, by providing the connecting device with a control circuit comprising a logic processing unit and a memory, the available charge can be determined and recorded over time, thus not only giving a reliable indication of the battery charge level, but also measuring energy consumption within a given time interval. This is particularly useful in that work vehicles, such as fork-lift trucks, are frequently hired, and electric energy consumption is a reliable parameter by which to determine cost.

Clearly, changes may be made to the connecting device as described herein without, however, departing from the scope of the present invention.

What is claimed is:

1) A connecting device for an electric work vehicle, comprising a supporting body (8) made of insulating material and housing at least a first and a second supply cable (10, 11) connectable to a battery (5); said first and second supply cable (10, 11) also being selectively connectable to a battery charger (7) and to at least one user device (3); an electronic control circuit (12) connected to said first and second supply cable (10, 11); and current transducer means (13) for detecting a current flowing in said first and second supply cable (10, 11), characterized in that said electronic control circuit (12) and said current transducer means (13)are housed in a seat (15) on said supporting body (8), and in that said supporting body (8) is configured for engagement with connecting elements (17a, 17b) of a connector, for connecting said battery charger (7) and said at least one user device (3) to said battery (5).

2) A device as claimed in claim 1, characterized in that said current transducer means (3) comprise a resistive element (16) located in series with said first or said second supply cable (10, 11); said resistive element (16) having, at opposite ends, a first and a second detecting contact (18, 19) connected to said electronic control circuit (12).

3) A device as claimed in any one of the foregoing claims, characterized in that said electronic control circuit (12) also comprises a current detecting circuit (28) connected to said first and second detecting contact (18, 19) of said current transducer means (13) and supplying a first control signal (S_{I}); a voltage detecting circuit (29) supplying a second control signal (S_{V}) related to a voltage (V_{B}) between said first and second supply cable (10, 11); and temperature sensing means (30).

4) A device as claimed in claim 3, characterized in that said electronic control circuit (12) comprises numeric processing means (23) connected to said current detecting circuit (28) and to said voltage detecting circuit to receive said first and second control signal (S_{I}, S_{V}), and to supply a number of enabling signals (EN1, EN2); memory means (25) connected to said numeric processing means (23); and serial communication means (26).

5) A system for supplying an electric work vehicle, and comprising and electric motor, a battery (5), a battery charger (7), and a connecting device (6) for connecting said battery (5) alternatively to said user device (3) and to said battery charger (7); characterized in that said connecting device (6) is as claimed in any one of claims 1 to 4.
